(19) United States
(12) Patent Application Publication
(10) Pub. No.: US 2013/0177017 A1
(43) Pub. Date: Jul. 11, 2013

(54) METHOD AND APPARATUS FOR REFLECTIVE MEMORY

(71) Applicants: David Charles Elliott, Ruckersville, VA (US); Thomas Dwayne Shannon, Ruckersville, VA (US); Harald Gruber, Augsburg (DE); Peter Missel, Augsburg (DE)

(72) Inventors: David Charles Elliott, Ruckersville, VA (US); Thomas Dwayne Shannon, Ruckersville, VA (US); Harald Gruber, Augsburg (DE); Peter Missel, Augsburg (DE)

(21) Appl. No.: 13/345,569

(22) Filed: Jan. 6, 2012

(51) Int. Cl. H04L 12/56

(52) U.S. Cl. 370/390

(57) ABSTRACT

A node has at least one memory module comprising at least one reflective memory region configured to reflect at least one reflective memory region of one or more other nodes, and the node and the one or more other nodes being configured to communicate on a packet-based serial point-to-point topology network. The node also comprises at least one network switch configured to provide at least two links each configured to connect to at least one non-host peer node on the network, multicast to the one or more other nodes at least one change to the at least one reflective memory region, receive from the one or more other nodes at least one other change to the at least one reflective memory region, and communicate to the at least one memory module the received at least one other change to the at least one reflective memory region.

### BACKGROUND OF THE INVENTION

1. Field of the Invention

The subject matter disclosed herein relates generally to the field of reflective memory and, more particularly, to the implementation of reflective memory in a network.

2. Brief Description of the Related Art

In general, reflective memory networks are real-time local area networks (LAN) in which every computer, or node in the network is able to have its local memory updated and/or replicated from a shared memory set. Each device constantly compares its local memory against the shared memory, and when something changes on the shared, it updates its local memory via a copy step. Similarly, when something on the local device changes, it writes to the shared memory so that all the other devices are able to update their local copy.

Currently, reflective memory networks are implemented in one or more point-to-point topology networks, such as a Peripheral Component Interconnect Express (PCIe) network. Traditionally, the point-to-point topology uses a star or fan-out topology. This topology requires extra hardware such as one or more central switches and a link (i.e., connection) between each memory device node and the central switch or hub in order to effectuate communications between end memory device nodes. Additionally, transactions to update reflective memory regions of various memory device nodes may require additional processing steps that can hinder network speed. As a result of the additional hardware, fixed number of nodes, and additional processing required by conventional reflective memory networks, a network with flexible topology and a reduced number of processing steps is desired that still takes advantage of the shared memory capabilities of reflexive memory.

### BRIEF DESCRIPTION OF THE INVENTION

The present invention describes embodiments of a method and apparatus for reflective memory. In one embodiment, a node for a network comprises at least one memory module comprising at least one reflective memory region configured to reflect at least one reflective memory region of at least one other node on the network. Additionally, the node may comprise at least one network switch communicatively connected to the at least one memory module. The network switch may further comprise a first switch port configured to provide a first link to a first non-host peer node on the network, a second switch port configured to provide a second link to either the first non-host peer node or a second non-host peer node on the network, and a third switch port configured to communicate with the at least one memory module. The at least one network switch may be configured to multicast to the at least one other node via at least one of the first switch port or the second switch port at least one outgoing message based on at least one change to the at least one reflective memory region of the at least one memory module. The network switch may also identify whether at least one incoming message received by at least one of the first switch port or second switch port. The message may comprise at least one message address corresponding to at least one memory address of the at least one reflective memory region of the at least one memory module. The network switch may also communicate to the at least one memory module, via the third switch port, the at least one incoming message in response to the identifying.

In another embodiment, a node comprises at least one memory module comprising at least one reflective memory region configured to reflect at least one reflective memory region of one or more other nodes, wherein the node and the one or more other nodes are configured to communicate on a packet-based serial point-to-point topology network. The node also may have at least one network switch that may be configured provide at least two links each configured to connect to at least one non-host peer node on the network and multicast to the one or more other nodes at least one change to the at least one reflective memory region of the at least one memory module. The network switch also may receive from the one or more other nodes at least one other change to the at least one reflective memory region. Additionally, the network switch may communicate to the at least one memory module the received at least one other change to the at least one reflective memory region.

In yet another embodiment, a method of reflecting memory comprises altering a portion of data of at least one reflective memory region of at least one memory module of a first node of a plurality of nodes on a network. The method also may include multicasting the alteration of the portion of data of the at least one reflective memory region of the at least one memory module to at least one other node of the plurality of nodes through at least one network switch of the first node. The network switch may comprise at least two switch ports. Each switch port may be configured to link to non-host peer nodes of the plurality of nodes on the network.

### BRIEF DESCRIPTION OF THE DRAWINGS

Regarding the brief description of the drawings,

FIG. 1 is a block diagram of a prior art example of a star topology for a network implementing reflective memory;

FIG. 2 is a block diagram of a node illustrating an example of an aspect of the invention;

FIG. 3 is a block diagram of at least one network topology illustrating at least one example of an aspect of the invention; and

FIG. 4 is a flow diagram illustrating an example method of an aspect of the invention.

### DETAILED DESCRIPTION OF THE INVENTION

With respect to the detailed description of the invention, reflective or reflected memory, replicated memory, or mirrored memory is a memory technology involving a network of distributed memory modules that cooperatively form a logically shared global address space with at least one, some, or all of the other memory modules in the reflective memory network. Individual memory modules maintain a shared copy of the data in their own reflective memory region so that all participating memory modules contain the same data within its own reflective memory region or space of each memory module. Generally, the reflective memory region comprises the same global address space in each memory module, (i.e., each memory module is configured to contain the reflective memory module at the same numerical memory address). However, various numerical offsets to the memory addresses of the reflective memory region between individual distributed memory modules may exist. Also, in one form, the size of the reflective memory region in each memory module is the same, thus allowing for each memory module to contain a full identical copy of the data encapsulated in the reflective memory region. However, variations in the size of the reflective memory region may exist between various memory modules.

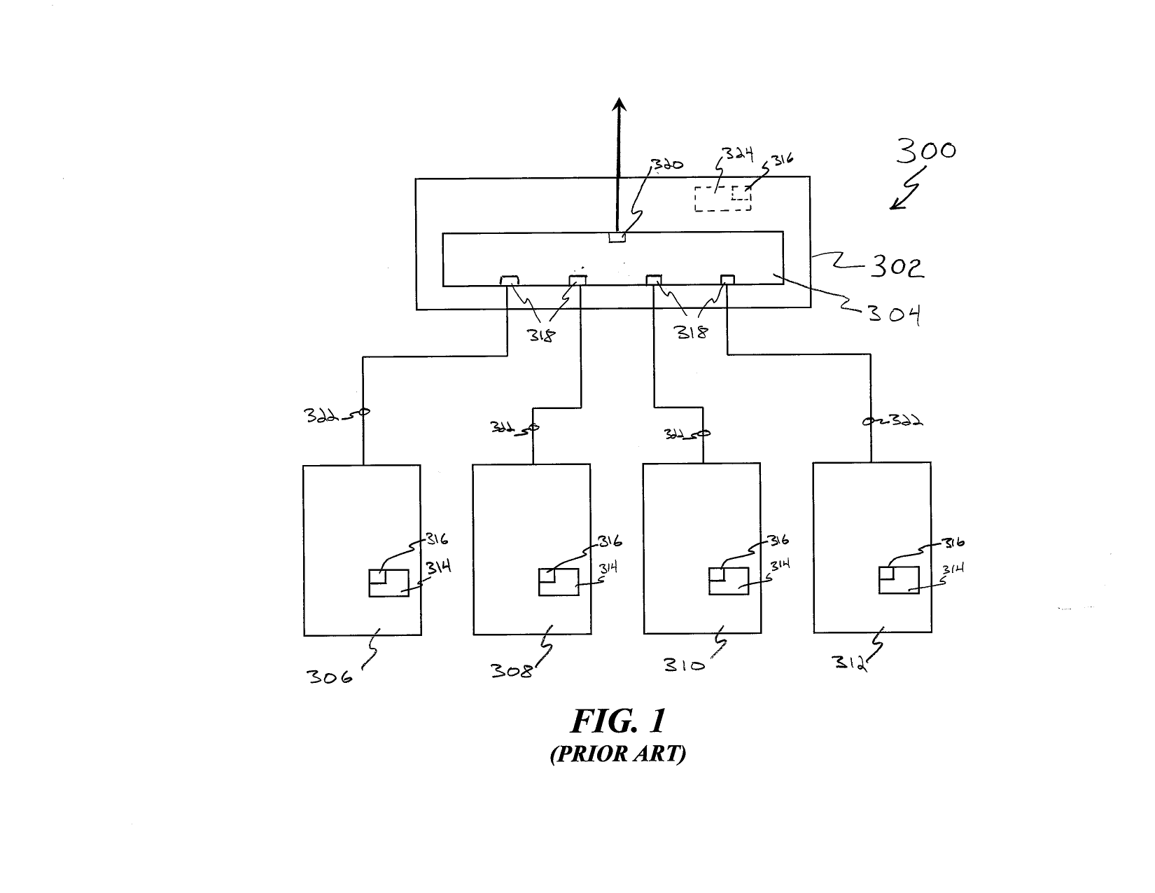

Referring to FIG. 1, a block diagram of a known example of a star topology for a network 300 implementing reflective memory is shown. This network 300 is a point-to-point network and is a Peripheral Component Interconnect Express (PCIe) network. The network 300 has a hub node 302, which further comprises a network switch 304. The network also comprises a plurality of nodes 306, 308, 310, 312 with each having a memory module 314. Each memory module 314 has a reflective memory region 316 shared with the other memory modules. The network switch 304 of the hub node 302 also has a plurality of ports 318. Optionally, the network switch 304 may have a port 320 to communicate with a host or another higher network element. Each non-host node 306, 308, 310, 312 is connected directly to the hub node's 302 network switch 304 via one or more links 322 providing each node 306, 308, 310, 312 with a dedicated connection. In some contexts, these links 322 may comprise point-to-point serial packet-based connections.

In such a PCIe network, these links 322 comprise point-to-point serial dedicated connections composed of one or more data pair lines (one to send and one to receive) called lanes. Usually each data line of the lane comprises two wires to create a differentially driven signal. Preferably, each link may comprise one, two, four, eight, twelve, sixteen, or thirty-two lanes, though other configurations may be utilized. When multiple lanes are used, serial data of the packet is striped across the multiple lanes and reconstructed into the serial packet at the receiving node. The lanes each carry one bit in each direction per cycle. Thus, a two lane (×2) configuration contains eight wires and transmits two bits at once in each direction, a four lane (×4) configuration contains sixteen wires and transmits four bits at once in each direction, and so on.

In order to perform the updating or alteration of the star topology network 300 reflective memory region 316, communication between the various nodes 306, 308, 310, 312 is effectuated through the network switch 304. This includes communication between various nodes 306, 308, 310, 312 to update or alter data of a reflected memory region 316 of the memory modules 314. For example, if the first node 306 performed a task updating a data value in the reflected memory region 316 of its memory module 314, to update the reflective memory regions 316 of the other nodes in the network 308, 310, 312, once requested, the first node would then have to communicate the data to the network switch 304 first, which in turn would communicate the information to the other nodes 308, 310, 312.

Alternatively, some systems may employ a hub node that further comprises a central memory module 324 configured to maintain a global copy of the reflective memory region 316. So configured, the plurality of nodes 306, 308, 310, 312 can each compare their respective reflective memory regions 316 of their memory modules 314 against those of the global copy in the central memory module 324, or may receive updates from the central memory module 324 whenever a value in the reflective memory region 316 has changed due to changes in another end point node 306, 308, 310, 312. Resultantly, for data written to the reflective memory region 316 by the first node 306 to be realized by the other nodes 308, 310, 312 require multiple transactions. The first node 306 must communicate the changed data to the central memory module 324 in the hub node 302, wherein the hub node 302 will then propagate the change to the other nodes 308, 310, 312.

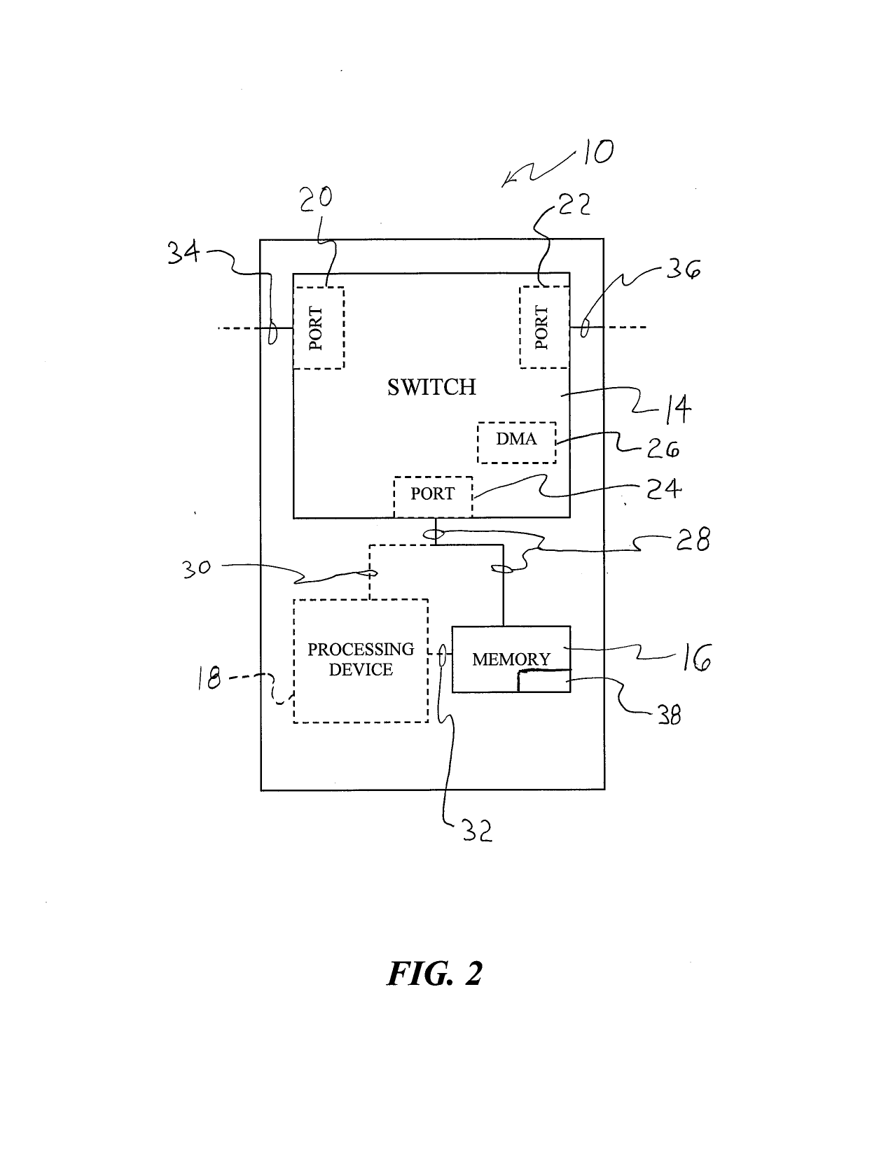

Turning now to FIG. 2, in contrast to the known network implementations described above, the subject matter of the present invention herein is directed to providing a network switch 14 in multiple network nodes 10 rather than a single hub network switch 302, 304 to service multiple endpoint nodes. Such nodes 10 may use multicasting to propagate alterations made to reflective memory regions 38 of respective memory modules 16. Thus, one technical effect is to allow for a flexible network topology beyond a star or fan-out topology and to remove the need for additional hardware nodes (such as the hub node 302). Another technical effect is to provide a reflective memory network through the use of multicasting reflective memory changes. An additional technical effect is to provide a faster reflective memory network by eliminating extra copy and/or read steps and removing a bottleneck when receiving data values of a reflective memory region 38.

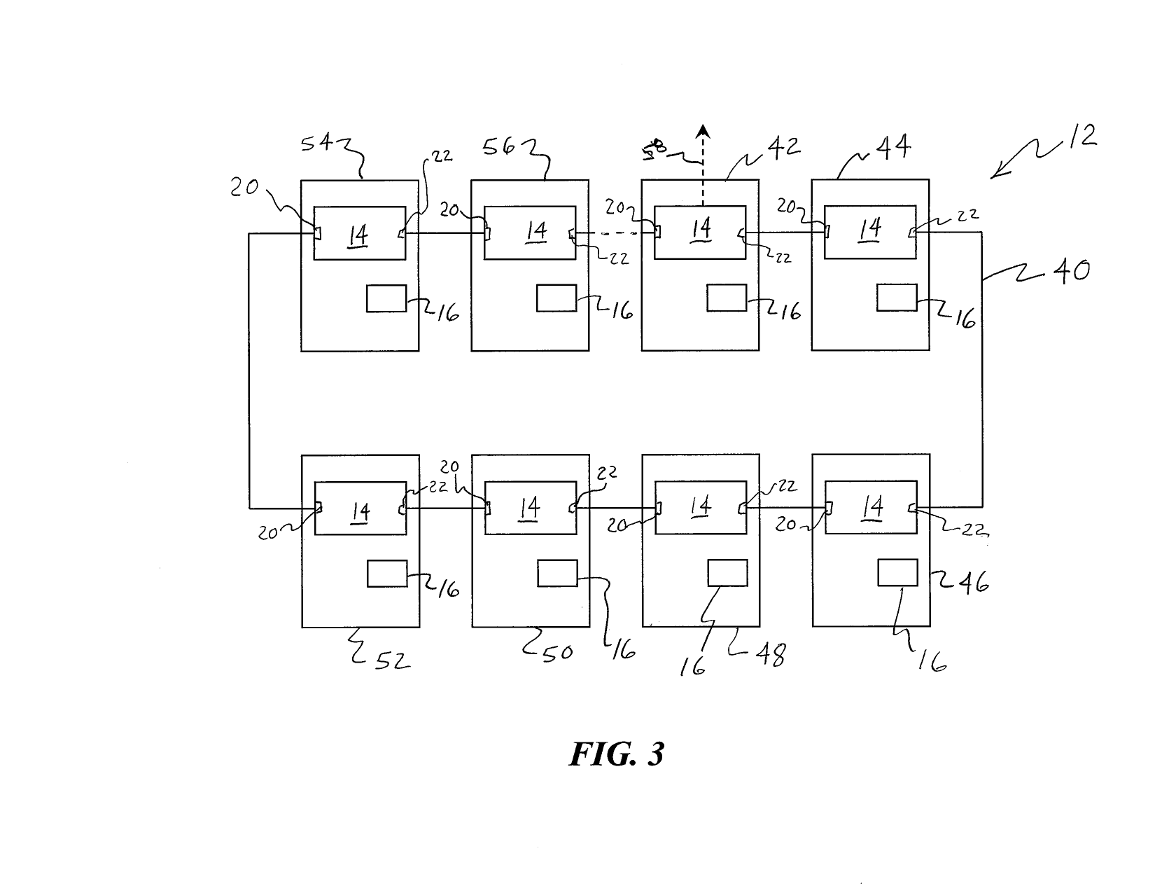

A node 10 for a network 12 (FIG. 3 of the present invention) comprises at least one network switch 14, at least one memory module or simply memory 16, and optionally by various approaches, a processing device 18. The network switch 14 may further comprise a first switch port 20, a second switch port 22, a third switch port 24, and, in at least one form, a Direct Memory Access (DMA) module 26.

The network switch 14 is communicatively connected to the memory module 16 via the third switch port 24 by a link 28. The third switch port 24 communicates with the memory module 16. Optionally, the processing device 18 may be connected to the memory module 16 and the at least one network switch via the links 30, 32. In another form, the first switch port 20 provides a first link 34 to a non-host peer node on the network 12, and the second switch port 22 provides a second link 36 to a non-host peer node, which may or may not be the same node linked to the first link 34. In yet another form, the links 28, 34, 36 from the first, second, and third switch ports 20, 22, 24, respectively, all have a same network scheme.

A non-host peer node on a network may be any peer node of the node 10 that is not a host of the node 10 or network 12. For example, and with brief reference to FIG. 3, nodes 42-56 (numbered evenly) all constitute peer nodes on a network 12. By some approaches, peer nodes act to partition tasks, workloads, processing, storage, functions or other resources among the peers so that some or all of the peers may operate together to perform these tasks. In contrast, a host node exists at a higher location in a larger network architecture. In one form, arrow 58 of peer node 42 may represent a connection to such a host. An example of a host node may comprise a central server to which the peer node network 12 reports to.

Returning now to FIG. 2, the memory module 16 comprises at least one reflective memory region 38 that reflects at least one reflective memory region 38 of at least one other node 10 on the network 12. As is previously described, reflective memory involves a network of distributed memory modules 16 that each logically share a global address space (i.e., the reflective memory regions 38). By one approach, the optional processing device 18 uses the reflected memory region 38 of the memory module 16 to perform at least one processing task. The processing task exceeds the scope of storing and propagating information relating to the reflected memory region 38. That is to say, the processing device 18 uses the information in the reflected memory region 38 to perform a task involved in producing at least one result relating to something other than the reflective memory region 38, such as operating, or providing data to, a program, for example.

The memory module 16 may include, but is not limited to, volatile or non-volatile memories, computer memories, read-only memories (ROM), random access memories (RAM), dynamic random access memories (DRAM), flash memories, magnetoresistive random access memories (MRAM), static random access memories (SRAM), addressable memories, dual-ported RAM, Double data rate synchronous dynamic random access memories (DDR SDRAM), Thyristor RAM (T-RAM), Zero-capacitor RAM (Z-RAM), Twin Transistor RAM (TTRAM), ferroelectric RAM (FeRAM), phase-change memory (PRAM), Programmable Metallization cell memories, conductive-bridging RAM (CBRAM), Silicon-Oxide-Nitride-Oxide-Silicon Ram (SONOS), resistive RAM (RRAM), racetrack memory, Nano-RAM, memories implemented in semiconductors (such as, for example, the optional processing device 18), or any other memory as are known in the art.

By one approach, the network switch 14 may be a multi-port switch or bridge switch. In operation, the network switch 14 receives messages (or packets by some approaches) on various switch ports 20, 22, 24 and selectively routes those messages (possibly altered in some forms or as-received in other forms) to one or more other switch ports 20, 22, 24. For example, the first switch port 20 may receive a message. Then, the network switch 14 selectively routes the message to both the second switch port 22 and the third switch port 24 and outputs the message from those switch ports 22, 24. As described, the first switch port 20 is configured to provide a first link 34 to a non-host peer node on the network, and the second switch port 22 is configured to provide a second link 36 to another non-host peer node on the network.

In one embodiment, the network switch 14 may be a Peripheral Component Interconnect Express (PCIe) switch. One example of a suitable PCIe switch is PLX Technologies part number PEX8717. Other suitable PCIe switches may also be utilized. When a PCIe switch is utilized, PCIe network communications are sent to and received from the PCIe network on either the first or the second switch port 20, 22 and either routed to/from the third switch port 24 to the internal PCIe network of the node (i.e., to the memory module 16 and/or to the optional processing device 18) and/or to/from the other switch port on the PCIe network (i.e., from the first switch port 20 to the second switch port 22, or vice versa).

In some forms, the first switch port 20 or the second switch port 22 (or both) may be a non-transparent switch port. As a non-limiting contextual example, the first switch port 20 is a non-transparent switch port which provides electrical and logical isolation between the non-transparent switch port 20 and the other ports 22, 24, thus providing the option for a separate memory domain at each port 20, 22, 24. When separate memory domains are present, address translation may be required by the network switch 14 to enable a message on the first memory domain located at the first switch port 20 (i.e., the non-transparent switch port) to be properly routed to the second memory domain located at the second switch port 22 (or, for example, at the third switch port 24).

So configured, the network switch 14 allows the node to be implemented in a non-star topology network 12 (FIG. 3) (though a star-topology is still possible with the current forms). Examples of non-star topologies include but are not limited to a ring topology (40 in FIG. 3), a line topology, and a tree topology, allowing flexibility with respect to topologies providing convenience of use and implementation. For example, a ring topology 40 may be preferred as it increases redundancy and parallelism in the network 12. Should a single failure occur at any point in the ring topology 40, due to its inherent redundancy, communication between the nodes 10 can remain intact, and the reflected memory 38 can remain intact at each node 10. Additionally, each node 10 is also capable of extending the network 12, thus eliminating the need for additional external hardware (such as the hub node 302 with network switch 304 of FIG. 1).

Referring now to FIGS. 2-3, there is illustrated a network 12 with the ring topology 40 that has eight nodes (42-56 numbered evenly), though any number of nodes 12 may be possible, including as few as two nodes 12. The nodes 42-56 each comprise at least one of the network switches 14, with at least the first switch port 20, the second switch port 22, and the third switch port 24, as previously described. Additionally, each node 42-56 comprises at least one of the memory modules 16 with at least one of the reflective memory regions 38. Each memory module 16 in each node 42-56 contains an identical copy of the data in the reflective memory region 38.

In this example ring topology 40, the second switch port 22 of the first node 42 is connected to the first switch port 20 of the second node 44, the second switch port 22 of the second node 44 is connected to the first switch port 20 of the third node 46, and so on, until the second switch port 22 of the eighth node 56 is connected to the first switch port 20 of the first node 42, thus creating a ring. An optional variation on this topology involves omitting the connection between the second switch port 22 of the eighth node 56 and the first switch port 20 of the first node 42, thus creating a line topology. These topologies as well as other topologies not shown here are possible by virtue of the network switch 14 being incorporated into each node 42-56 of the topology rather than a single hub switch to service multiple endpoint nodes.

To effectuate propagation of at least one change or alteration made to the reflective memory region 38 at a node 12, the network switch 14 multicasts the change to at least one other node 12 with a reflective memory region 38 via the first switch port 20 or the second switch port 22. For example, the first node 42 may perform processing to alter a portion of data of its reflective memory region 38 to update a value in the reflective memory region 38. The change is then multicast to the other nodes 44-56. More specifically, multicasting involves propagating the change to the reflective memory region 38 of an originating node 42 to all other nodes 44-56, thus updating the reflective memory region 38 of their local memory modules 16. In at least one form, the network switch 14 of the originating node 42 is further configured to multicast without receiving a request for updated information from the other nodes 44-56. In this regard, any of the nodes 42-56 may be the originating node and may follow the above procedure to effectuate propagation of alterations made to the reflective memory region.

By one approach, multicast messages from the originating node 42 will contain information indicating that the message is a multicast message. One such indication may be a flag within a header of the message. Another indication may be an address in the message, which such address indicates that it is a multicast message. For example, if an address range for a multicast message is from 0xA0000000 to 0xA00FFFFF and the message contains address 0xA0001000, the address itself may indicate that it is a multicast message. So configured, a network switch 14 receiving this message with such a message address may identify that the message corresponds to at least one memory address of the reflective memory region 38 of its memory module 16.

Network switches 14 of the other nodes 44-56 containing the reflective memory regions 38 receive and accept multicast messages on at least one switch port (i.e., the first switch port 20). Upon receipt of the multicast message at either the first switch port 20 or the second switch port 22, the network switch 14 of the recipient nodes 44-56 will determine whether the node 44-56 is to receive the multicast message (versus being limited to non-multicast message handling). The switch 14 may further determine whether the message is to be routed at least to the third switch port 24. Upon routing to the third switch port 24, the message is eventually acted upon by the at least one memory module 16 updating at least one data value of its reflective memory region 38. The network switch 14 of at least one of the recipient nodes 44-56 may also rout the message to its second switch port 22 (if received on the first switch port 20, or vice versa) for further propagation through the network 12.

In effect in this example, once the first node 42 alters its reflective memory region 38, it forms a message, which is then multicast out through at least one of the first or second switch ports 20, 22, or in one form both ports 20, 22. The second node 44 receives the message on its first switch port 20. The network switch 14 at the second node 44 determines that it is a multicast message, that the unit is configured to receive multicast messages, and that the message is to be routed to its third switch port 24. The message is then received (altered or not altered) by the memory module 16 when the node is configured to receive multicast messages. The message is also forwarded to the second switch port 22 to continue transmission of the multicast message to the third node 46. This continues until all nodes 44-56 have been updated. A similar process may occur at the eighth node 56 and operate simultaneously in the opposite direction.

To further aid the process of multicasting with respect to reflective memory regions 38, by one approach, the network switch 14 may further comprise a Direct Memory Access (DMA) module 26. So configured, the network switch 14 communicates the message to the memory module 16 via the third switch port 24 by using the DMA module 26 to directly access the memory module 16. Additionally, the network switch 14 multicasts to the other nodes 44-46 by using the DMA module 26 to directly access the memory module 16. This permits the network switches 14 to read/write directly from/to the memory module 16 without the aid of an additional processing device 18. This frees up processor resources in a processing device 18 and effectively provides a readily implementable multicasting scheme.

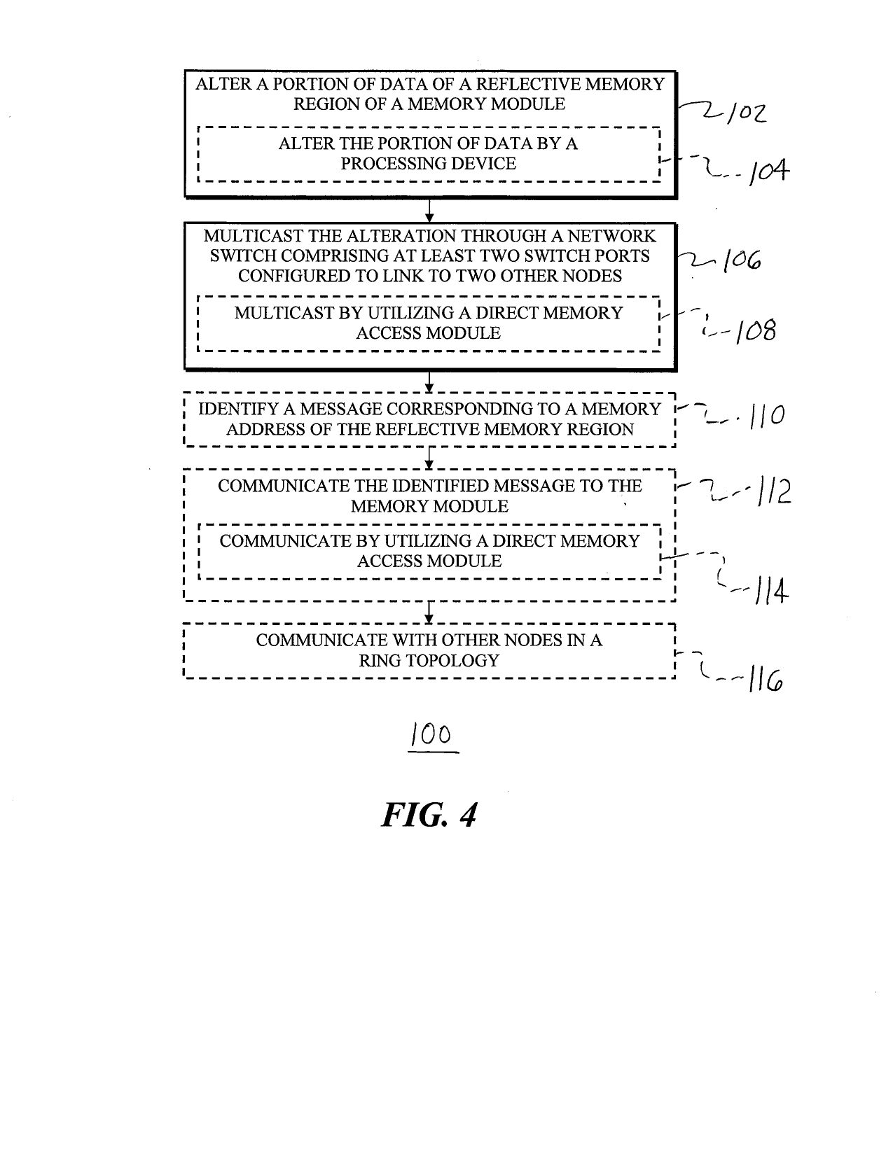

Referring now to FIG. 4, a flow diagram illustrates a method 100 in accordance with various aspects, including altering 102 a portion of data of at least one reflective memory region 38 of at least one memory module 16 of a first node 42 of a plurality of nodes 42-56 on a network 12. Optionally, the altering 104 may be performed by at least one processing device 18 operatively connected to a network switch 14. The alteration may be multicast 106 to at least one other node 44 of the plurality of nodes 42-56. The network switch 14 comprises at least two switch ports 20, 22 with each switch port configured to link to non-host peer nodes (previously described) of the plurality of nodes on the network. Optionally, the multicast is performed by utilizing 108 at least one Direct Memory Access (DMA) module 26 to directly access the at least one memory module 16.

By one approach, the method 100 comprises identifying 110 at least one message received by one or both of the first or second switch ports 20, 22. The message may have a message address corresponding to at least one memory address of the reflective memory region 38. By another approach, at least a portion of the identified message is communicated 112 to the memory module 16 via a third switch port 24 of the network switch 14. Optionally, the communication 112 to the memory module 16 may occur by utilizing 114 at least one Direct Memory Access (DMA) module 26 to directly access the at least one memory module 16. Lastly, by at least one other approach, the node 42 communicates 116 with the one other node 44-56 over the network 12 in a ring topology 40. Optionally, in at least one example, the network 12 may be a Peripheral Component Interconnect Express (PCIe) network. Further, the other node 44 on the network may possibly also have a memory module 16 and network switch 14 as previously described.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A node for a network comprising:
at least one memory module comprising at least one reflective memory region configured to reflect at least one reflective memory region of at least one other node on the network; and
at least one network switch communicatively connected to the at least one memory module and comprising:
a first switch port configured to provide a first link to a first non-host peer node on the network,
a second switch port configured to provide a second link to either the first non-host peer node or a second non-host peer node on the network, and
a third switch port configured to communicate with the at least one memory module, and
the at least one network switch is configured to:
multicast to the at least one other node via at least one of the first switch port or the second switch port at least one outgoing message based on at least one change to the at least one reflective memory region of the at least one memory module;
identify whether at least one incoming message received by at least one of the first switch port or second switch port comprises at least one message address corresponding to at least one memory address of the at least one reflective memory region of the at least one memory module; and
communicate to the at least one memory module via the third switch port the at least one incoming message in response to the identifying.

2. The node of claim 1 wherein the network further comprises a Peripheral Component Interconnect Express (PCIe) network and the at least one network switch further comprises a PCIe switch.

3. The node of claim 1 wherein the at least one other node on the network comprises the at least one memory module and the at least one network switch.

4. The node of claim 1 further comprising at least one processing device operatively connected to the at least one network switch and the at least one memory module and configured to utilize the at least one reflected memory region of the at least one memory module to perform at least one processing task, wherein the at least one processing task exceeds the scope of storing and propagating information relating to the at least one reflected memory region.

5. The node of claim 1 wherein the at least one network switch further comprises a Direct Memory Access (DMA) module and wherein the at least one network switch is further configured to communicate to the at least one memory module via the third switch port the at least one message identified by the first switch port and multicast to the at least one other node by utilizing the DMA module to directly access the at least one memory module.

6. The node of claim 1 wherein the node is configured in a ring topology with the at least one other node.

7. The node of claim 6 wherein each node forming a ring portion of the ring topology comprises at least one of the at least one network switches.

8. The node of claim 1 wherein the reflective memory region of the node and the at least one other node cooperatively comprises a global memory address space.

9. The node of claim 1 wherein the at least one network switch is configured to multicast without receiving a request for updated information.

10. A node comprising:
at least one memory module comprising at least one reflective memory region configured to reflect at least one reflective memory region of one or more other nodes, and the node and the one or more other nodes being configured to communicate on a packet-based serial point-to-point topology network; and
at least one network switch configured to:
provide at least two links each configured to connect to at least one non-host peer node on the network,
multicast to the one or more other nodes at least one change to the at least one reflective memory region of the at least one memory module,
receive from the one or more other nodes at least one other change to the at least one reflective memory region, and
communicate to the at least one memory module the received at least one other change to the at least one reflective memory region.

11. The node of claim 10 wherein the at least one network switch is further configured to provide a first link of the at least two links to a first non-host peer node, a second link of the at least two links to a second non-host peer node, and a third link to the at least one memory module, and each of the first, second, and third links having a same network scheme.

12. The node of claim 10 wherein the packet-based serial point-to-point topology network comprises a Peripheral Component Interconnect Express (PCIe) network.

13. A method of reflecting memory comprising:
altering a portion of data of at least one reflective memory region of at least one memory module of a first node of a plurality of nodes on a network; and
multicasting the alteration of the portion of data of the at least one reflective memory region to at least one other node of the plurality of nodes through at least one network switch of the first node comprising at least two switch ports, and each switch port configured to link to non-host peer nodes of the plurality of nodes on the network.

14. The method of claim 13 further comprising
identifying at least one message received by at least one of the first or second switch ports comprising at least one message address corresponding to at least one memory address of the at least one reflective memory region of the at least one memory module; and
communicating to the at least one memory module via a third switch port at least a portion of the at least one identified received message.

15. The method of claim 14 further comprising multicasting the alteration of the portion of data of the at least one reflective memory region of the at least one memory module to the at least one other node of the plurality of nodes and communicating to the at least one memory module via a third switch port the at least one identified received message by utilizing at least one Direct Memory Access (DMA) module to directly access the at least one memory module.

16. The method of claim 13 wherein the network comprises a Peripheral Component Interconnect Express (PCIe) network.

17. The method of claim 13 wherein the altering the portion of data of the at least one reflective memory region of the memory module further comprises at least one processing device operatively connected to the at least one network switch and the at least one processing device altering the portion of data.

18. The method of claim 13 further comprising multicasting the alteration of the portion of data of the at least one reflective memory region of the at least one memory module to the at least one other node of the plurality of nodes by utilizing a Direct Memory Access module to directly access the at least one memory module.

19. The method of claim 13 further comprising the node communicating with the at least one other node over the network in a ring topology.

20. The method of claim 13 wherein the at least one other node on the network comprises the at least one memory module and the at least one network switch.
